(19) United States
(12) Patent Application Publication
(10) Pub. No.: US 2007/0162860 A1
(43) Pub. Date: Jul. 12, 2007

(54) Remote console for observing multiple workstations

(75) Inventors: Girish Muralidharan, Waukesha, WI (US); John D. Hoford, Pewaukee, WI (US)

Correspondence Address: PETER VOGEL;GE HEALTHCARE, 3000 N. GRANDVIEW BLVD., SN-477, WAUKESHA, WI, 53188, US

(73) Assignee: General Electric Company

(21) Appl. No.: 11/329,801

(22) Filed: Jan. 11, 2006

(51) Int. Cl. G06F 15/177; G06F 15/173

(52) U.S. Cl. 715/736; 709/224

(57) ABSTRACT

A remote viewing system includes a plurality of local workstations and a remote console. Each of the local workstations provides screen update data. The remote console is operable to receive the screen update data from the plurality of local workstations and display the screen update data for at least two of the local workstations on a display. A method for remotely interfacing with a plurality of local workstations, each providing screen update data, includes receiving the screen update data from each of the local workstations. The screen update data for at least two of the local workstations is displayed on a display.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

The field of the invention relates generally to the observation of multiple workstations, and more particularly to the simultaneous observation and/or operation of a plurality of workstations by a remote console.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art.

Medical institutions and facilities offer an increasingly wide range of services and procedures to address the needs of the patients. The services offered by the medical institutions, such as hospitals, clinics, and other medical facilities, may include medical imaging of the patients. A wide variety of medical imaging systems, such as x-ray system, computed tomography (CT) system, positron emission tomography (PET) system, electron beam tomography (EBT) system, magnetic resonance imaging (MRI) system, ultrasound system, tomosynthesis system, and so forth may be utilized in the medical facilities. The medical imaging systems may produce detailed images of a patient's internal tissues and organs, thereby mitigating the need for invasive exploratory procedures and providing valuable tools for identifying and diagnosing disease or for verifying wellness.

To provide support for the medical imaging systems, technicians and other support personnel may be utilized to train personnel on the operation of the medical imaging systems and/or to troubleshoot problems with the medical imaging systems. Though the number of these imaging systems has increased, the personnel qualified to service the imaging systems or assist in instructing new technicians in their use has not increased at the same rate. In addition, because the medical imaging systems may be geographically dispersed, the support of these imaging systems may be very costly. It may not be feasible for a technician to travel to each medical imaging system to provide the training and/or the troubleshooting needed.

To address the cost and support issues, the instructors and/or the technicians may remotely interact with the local operator workstation through a remote console observation to provide training and/or troubleshooting for the imaging system. The remote console observation may utilize a network that connects the local operator workstation at the imaging system with the remote operator workstation to provide the interaction between the systems. By utilizing the network for this interaction, travel time and costs associated with the servicing and training of personnel for the medical imaging systems may be reduced. For example, a remote service technician may access the imaging system to perform diagnostic routines, to configure imaging settings, or to train; a local operator of the imaging system, while being located in a centralized service center.

Previous remote observation systems allow a single connection between the local operator and the remote console. Hence, a one-to-one ratio of training personnel to trainees is required. Hence, when a new tool or interface is released a trainer may have to repeat the same training for many different operators, which it time consuming and expensive.

The present invention is directed to overcoming, or at least reducing the effects of, one or more of the problems set forth above.

### BRIEF SUMMARY OF THE INVENTION

One aspect of the present invention is seen in a remote viewing system including a plurality of local workstations and a remote console. Each of the local workstations provides screen update data. The remote console is operable to receive the screen update data from the plurality of local workstations and display the screen update data for at least two of the local workstations on a display.

Another aspect of the present invention is seen in a method for remotely interfacing with a plurality of local workstations. Each local workstation provides screen update data. The method includes receiving the screen update data from each of the local workstations. The screen update data for at least two of the local workstations is displayed on a display.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a simplified block diagram of a medical imaging system including multiple remote workstations in accordance with one aspect of the present invention; and

FIGS. 2, 3, 4, and 5 illustrate exemplary display layouts for monitoring and controlling the remote workstations in the system of FIG. 1.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

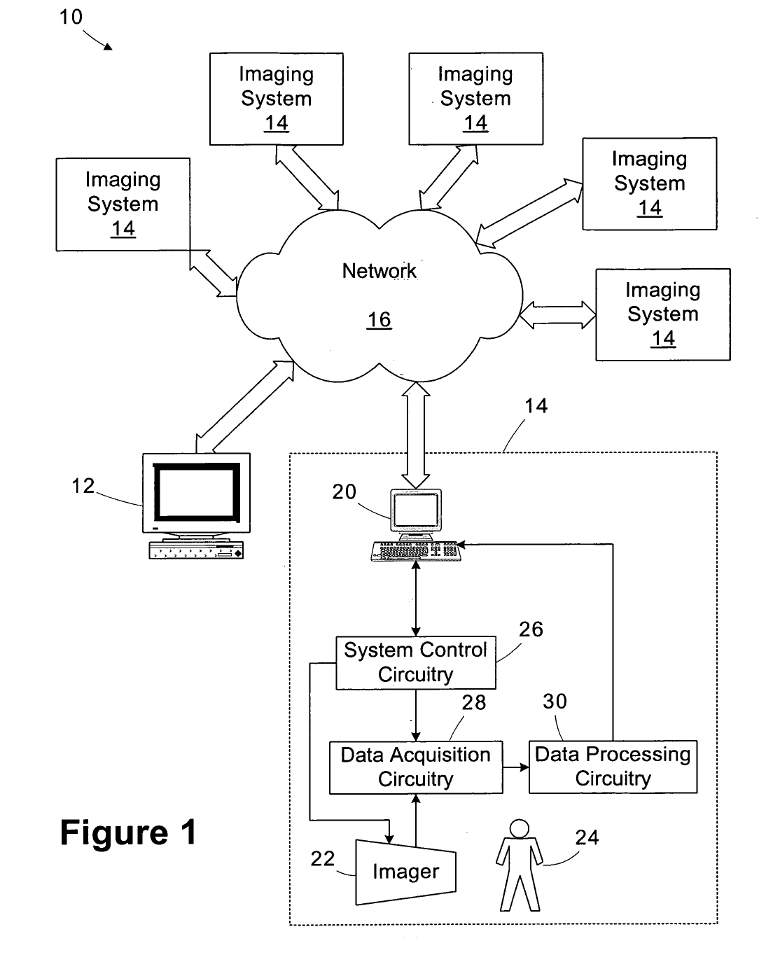

Turning now to the drawings, referring initially to FIG. 1, an exemplary medical imaging system 10 is depicted. The medical imaging system includes a remote console 12 and a plurality of imaging systems 14. The imaging systems 14 may be located within a common facility or geographically dispersed amongst numerous facilities. The remote console 12 is remote in that it may not be physically located in the proximity of the imaging systems 14. Each imaging system 14 maintains a connection over a network 16 with the remote console 12. The type of network 16 employed may vary depending on the distances between the remote console 12 and the imaging systems 14. For instance, if the imaging systems 14 are operated in the same facility or by the same entity, a local area network, or wide area networks may be used. For more dispersed imaging systems 14, a global network, such as the Internet, may be used. For instance, the network 16 may include a local intranet within the medical facility, a service network between the medical facility and the remote console 12, a direct communication line between the imaging system 14 and the remote console 12, a virtual private network (VPN) established over the Internet, and so forth. In general, the network 16 allows data exchange between the remote console 12 and one or more components of the imaging systems 14. As will be appreciated by those skilled in the art, any suitable circuitry, such as modems, routers, switches, servers, firewalls, and so forth may be included within the network 16. Various security protocols are known in the art and may be used to secure the connections employed over the network 16.

A user operating the remote console 12 may simultaneously observe or interact with all of the imaging systems 14. Each of the imaging systems 14 is typically complex and requires periodic maintenance and/or periodic instruction for technicians or personnel using the imaging system 10. As the availability of qualified service technicians may be limited, remote access for training and diagnostics purposes may be utilized. The connections between the remote console 12 and the imaging system 14 may allow the transfer of images as well as bi-directional voice or text communication.

One of the imaging systems 14 is illustrated in greater detail. The operations and functions of the imaging system 14 may be controlled by a local operator workstation 20. Generally, the imaging system 14 includes an imager 22 that detects signals and converts the signals into useful data. As described more fully below, the imager 22 may operate in accordance with various physical principals for creating the image data. The imager 22 creates image data indicative of regions of interest in a patient 24, either in a conventional film or in a digital media.

The imager 22 operates under the control of system control circuitry 26. The system control circuitry 26 may include a wide variety of circuits, such as radiation source control circuits, timing circuits, circuits for the coordination of data acquisition in conjunction with patient or table movement, circuits for controlling the position of the radiation source and detectors and so forth. In the present context, the system control circuitry 26 may also include memory elements for storing programs and routines executed by the system control circuitry 26 or by associated components of the imaging system.

The imager 22, following acquisition of the image data or signals, may process the signals, such as for conversion to digital values, and forward the image data to data acquisition circuitry 28. In the case of analog media, such as photographic film, the data acquisition system may generally include supports for the film, as well as equipment for developing the film and producing hard copies that may be subsequently digitized. For digital systems, the data acquisition circuitry 28 may perform a wide range of initial processing functions, such as adjustment of digital dynamic ranges, smoothing or sharpening of data, as well as compiling of data streams and files, where desired. The data may then be transferred to data processing circuitry 30 where additional processing and analysis are performed. For conventional media such as photographic film, the data processing system may apply textual information to films, as well as attach certain notes or patient-identifying information. For the various digital imaging systems available, the data processing circuitry 30 perform substantial analyses of data, ordering of data, sharpening, smoothing, feature recognition, and so forth. The acquired images or image data may be stored in short or long-term storage devices, such as picture archiving communication systems, which may be comprised within or remote from the imaging system 14.

The local operator workstation 20 interfaces with the system control circuitry 26. The local operator workstation 20 may include one or more general purpose or application specific computers or processor-based components. The local operator workstation 20 may include a monitor or other visual display and one or more input devices. The monitor and input devices may be used for viewing and inputting configuration information or for operating the imaging system 14, in accordance with the techniques discussed herein. As with the system control circuitry 26, the local operator workstation 20 may communicate with a memory or data storage component for storing programs and routines executed by the local operator workstation 20 or by associated components of the imaging system 14. It should be understood that any type of computer accessible memory or storage device capable of storing the desired amount of data and/or code may be accessed by the local operator workstation 20. Moreover, the memory or storage device may comprise one or more memory devices, such as magnetic or optical devices, of similar or different types, which may be local and/or remote to the imaging system 14.

It should be noted that a serving station, such as the local operator workstation 20, may be a laptop, a workstation, a server, or any other suitable device that may receive image data and transmit the image data. Also, it should be noted that more than a single local operator workstation 20 may be provided within a particular imaging system 14. For example, an imaging system 14 may include an interface which permits regulation of the parameters involved in the image data acquisition procedure, whereas a different operator interface may be provided for manipulating, enhancing, and viewing the reconstructed images.

The remote console 12 may be located in or associated with a service provider. The service provider may include a facility or facilities for providing training and technical assistance based on a subscription or contract basis. The remote console 12 allows a remote operator to access elements of the imaging systems 14 via the network 16. In particular, the remote console 12 may allow a remote operator to configure parameters associated with a scanning operation, access or initiate service operations, configure the processing of acquired scan data, and so forth.

To remotely observe the imaging systems 14 from the remote console 12, screen update data may be transmitted from the local operator workstations 20 or the imaging systems 14 to the remote console 12. The remote console 12 may receive the screen update data and display the images and information via a monitor 34. The screen update data may include screen information that is utilized to display information and detailed images of a patient's anatomy, such as internal tissues and organs. The remote console 12 and local operator workstation 20 may utilize remote frame buffer (RFB) protocol, X windows protocol, independent computing architecture (ICA) protocol, or other similar protocol to communicate the screen updates. The protocols may be an implementation of virtual network computing or other similar software to provide for remote training or diagnostics. The communication links may also allow bi-directional voice or text communication.

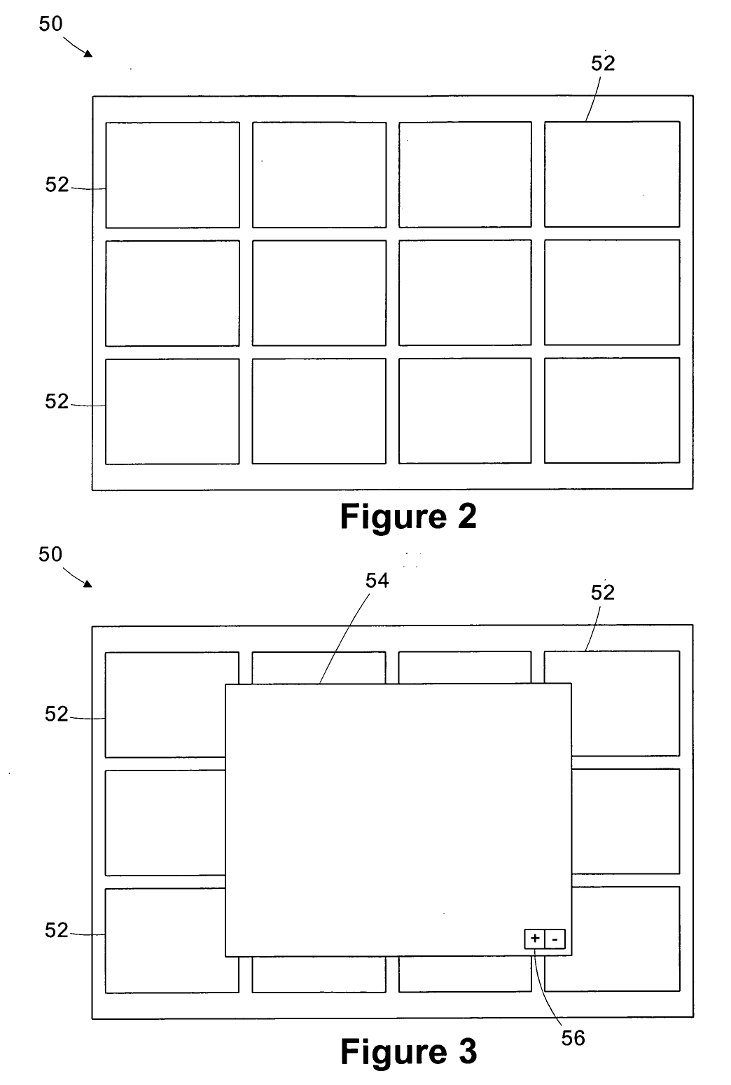

Turning to FIG. 2, a diagram illustrating an exemplary display screen 50 employed by the remote console 12 is provided. The display screen 50 is divided into a plurality of frames 52, each associated with one of the local operator workstation 20 at the imaging systems 14. The remote console 12 receives screen update data from each of the local operator workstations 20 and displays it in the associated frame 52. The operator of the remote console 12 may then observe all of the local operator workstations 20 simultaneously. Because, the size of each frame 52 is typically smaller than the display employed at the imaging system 14, the screen update data may be compressed, averaged, or reduced in some other manner prior to sending to the remote console 12 to reduce bandwidth requirements over the network 16. The performance of the network 16 may impact the remote observation of the local operator workstations 20. Because the network 16 may be outside the control of the imaging system's operator or technician, it may be desirable to adjust the image updates transmitted to the remote console 12 based on congestion or latency on the network 16. In making these adjustments, it may further be advantageous to dynamically or automatically adjust the interaction based on the network performance without manual intervention by the operator. In this manner, the remote observation between the local operator workstation 20 at imaging system 10 and the remote console 12 may be able to compensate for network performance.

While monitoring the local operator workstations 20 via the frames 52, the operator of the remote console 12 may communicate instructions to the local operators of the imaging systems 14 for training purposes. These instructions may be communicated by voice, text, or other means incorporated into the software application implementing the remote console interface. For example, the operator of the remote console 12 may demonstrate features of a new interface or imaging procedure. By monitoring the local operator workstations 20, the operator of the remote console 12 may readily identify those local operators that are having difficulty with the instructed procedures.

Referring to FIG. 3, the operator of the remote console 12 may select a particular one of the frames 52 for increased attention (e.g., due to an observed problem situation or a query from the local operator of the imaging system 14. Selecting the frame 52 causes the screen image to be displayed in an expanded frame 54 that may be displayed on the screen 50 in manner that may partially overlap one or more of the other frames 52. The zoom level of the expanded frame 54 may also be selected by the operator of the remote console 12 using a zoom control 56.

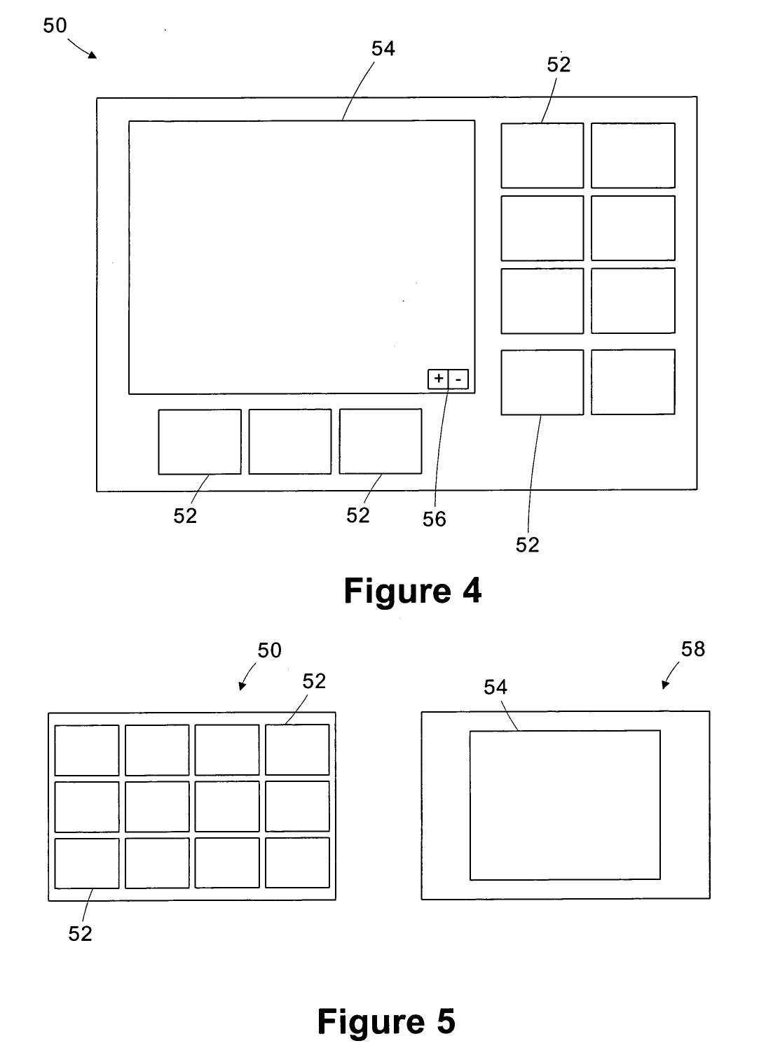

In another embodiment shown in FIG. 4, the frames 52 may be further reduced and rearranged to allow display of both the expanded frame 54 and the remaining frames 52.

In yet another alternative embodiment, as shown in FIG. 5, the remote console 12 may be equipped with multiple monitors, with the screen 50 including the multiple frames 52 being displayed on one monitor; while the frame 54 associated with a selected local operator workstation 20 is displayed on a second monitor, as represented by screen 58.

In embodiments, where the screen update data is reduced or compressed to reduce bandwidth, the screen update data of the local operator workstation 20 associated with the expanded frame 54 may be left in an unreduced state, providing the operator of the remote console 12 an enhanced view of the screen update data.

The expanded frame 54 may also be used by the operator of the remote console 12 to take over control of the associated local operator workstations 20 for purposes of servicing or troubleshooting the imaging system 14 or providing additional training to he local operator. The operator of the remote console 12 may remotely control one of the imaging systems 14, while maintaining the observation of the remaining imaging systems 14. In this manner, a local operator who is having difficulty may be assisted without interrupting the other local operators.

Although the invention is described as it may be implemented in a medical imaging system 10, its application extends to other systems not related to medical imaging. For example, training personnel in a corporation may use the remote console 12 to interface with multiple local workstations 20 to provide training or assistance with various software or hardware applications, depending on the nature of the equipment associated with the local workstations. In an office environment, the operator of the remote console 12 may provide training or monitor the usage of various software tools; such as word processing, spreadsheet, drawing, accounting, or other software applications. In a manufacturing environment, the local workstations may be attached to manufacturing tools or networks, and the remote console operator may provide training or observe local operators interfacing with various manufacturing processes. In a help desk situation, a technician may assist multiple users with computer issues simultaneously.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A remote viewing system, comprising:
a plurality of local workstations, each providing screen update data; and
a remote console operable to receive the screen update data from the plurality of local workstations and display the screen update data for at least two of the local workstations on a display.

2. The remote viewing system of claim 1, wherein the remote console is operable to display a plurality of frames on the display, each frame displaying the screen update data for one of the local workstations.

3. The remote viewing system of claim 2, wherein the remote console is operable to control the operation of the local workstation associated with at least one of the frames.

4. The remote viewing system of claim 2, wherein a selected frame of the plurality of frames has a size greater than the remaining frames of the plurality of frames.

5. The remote viewing system of claim 4, wherein the selected frame overlaps at least one of the remaining frames.

6. The remote viewing system of claim 4, wherein the remote console comprises first and second display devices, the selected frame is displayed on the first display device, and the remaining frames are displayed on the second display device.

7. The remote viewing system of claim 4, wherein the remote console is operable to control the operation of the local workstation associated with the selected frame.

8. The remote viewing system of claim 4, wherein the screen update data from the local workstations associated with the remaining frames is reduced with respect to the screen update data from the local workstation associated with the selected frame.

9. The remote viewing system of claim 1, wherein the local workstations comprise medical imaging workstations.

10. A method for remotely interfacing with a plurality of local workstations, each providing screen update data, comprising:
receiving the screen update data from each of the local workstations; and
displaying the screen update data for at least two of the local workstations on a display.

11. The method of claim 10, further comprising displaying a plurality of frames on the display, each frame displaying the screen update data for one of the local workstations.

12. The method of claim 11, further comprising controlling the operation of the local workstation associated with at least one of the frames.

13. The method of claim 11, wherein displaying the plurality of frames on the display comprises displaying a selected frame of the plurality of frames having a size greater than the remaining frames of the plurality of frames.

14. The method of claim 13, wherein the selected frame overlaps at least one of the remaining frames.

15. The method of claim 13, wherein the display comprises first and second display devices, and the method further comprises:
displaying the selected frame on a first display device; and
displaying the remaining frames on the second display device.

16. The method of claim 13, further comprising controlling the operation of the local workstation associated with the selected frame.

17. The method of claim 13, wherein the screen update data from the local workstations associated with the remaining frames is reduced with respect to the screen update data from the local workstation associated with the selected frame.

18. The method of claim 10, wherein the local workstations comprise medical imaging workstations.

19. A system for remotely interfacing with a plurality of local workstations, each providing screen update data, comprising:
means for receiving the screen update data from each of the local workstations; and
means for displaying the screen update data for at least two of the local workstations on a display.
